(19) United States
(12) Patent Application Publication
(10) Pub. No.: US 2025/0191249 A1
(43) Pub. Date: Jun. 12, 2025

(54) VIRTUAL IMMUNOFLUORESCENCE STAINING OF TISSUE SAMPLES USING DEEP LEARNING

(71) Applicant: Verily Life Sciences LLC, Dallas, TX (US)

(72) Inventors: Jessica Loo, San Francisco, CA (US); Yang Wang, San Francisco, CA (US); Peter Cimermancic, Mountain View, CA (US); Sudha Rao, Los Altos, CA (US); Pok Fai Wong, San Francisco, CA (US)

(21) Appl. No.: 18/966,845

(22) Filed: Dec. 3, 2024

Related U.S. Application Data
(60) Provisional application No. 63/607,137, filed on Dec. 7, 2023.

(51) Int. Cl. G06T 11/00

(52) U.S. Cl. CPC G06T 11/001; G06T 2210/41

(57) ABSTRACT

Example systems and methods for generating virtual immunofluorescence stains for tissue samples are provided. A computing device receives a slide image of a target tissue sample of a particular tissue type. The computing device selects a first trained machine learning (ML) model to generate virtual immunofluorescence (IF) stains of a first type for the particular tissue type based on a user input. The first trained ML model is trained at least based on a first set of stain images of a plurality of training tissue samples with stains of the first type. The computing device generate a virtually stained image of the target tissue sample with the virtual IF stains of the first type using the first trained ML model. The computing device displays the virtually stained image of the target tissue sample with the virtual IF stains of the first type.

### CROSS-REFERENCE TO RELATED APPLICATIONS

This application claims priority to U.S. Provisional Patent Application No. 63/607,137, filed Dec. 7, 2023, titled “VIRTUAL IMMUNOFLUORESCENCE STAINING OF TISSUE SAMPLES USING DEEP LEARNING,” the entirety of which is hereby incorporated by reference.

### FIELD

The present application generally relates to virtual staining and more particularly relates to virtual immunofluorescence staining of tissue samples using deep learning.

### BACKGROUND

Interpretation of tissue samples to determine the presence of certain disease (e.g., cancer) requires substantial training and experience with identifying features that may indicate cancer or other diseases. Typically, a pathologist will receive a slide containing a slice of tissue and examine the tissue to identify features, e.g., biomarkers, that may be used to diagnose the disease or indicate a type of treatment that may be effective on the disease. Staining techniques have been used to visualize different markers or structures within cells and tissues, which allows pathologists to classify cells, monitor cellular processes, and assess different diseases.

### SUMMARY

Various examples are described for virtual immunofluorescence staining of tissue samples using deep learning. One example method includes receiving a slide image of a target tissue sample of a particular tissue type; selecting a first trained machine learning (ML) model to generate virtual immunofluorescence (IF) stains of a first type for the particular tissue type; generating a virtually stained image of the target tissue sample with the virtual IF stains of the first type using the first trained ML model; and providing the virtually stained image of the target tissue sample with the virtual IF stains of the first type.

One example system for virtual immunofluorescence staining of tissue samples using deep learning includes a non-transitory computer-readable medium; one or more processors in communication with the non-transitory computer-readable medium, the one or more processors configured to execute processor-executable instructions stored in the non-transitory computer-readable medium configured to cause the one or more processors to receive a slide image of a target tissue sample of a particular tissue type; select a first trained machine learning (ML) model to generate virtual immunofluorescence (IF) stains of a first type for the particular tissue type; generate a virtually stained image of the target tissue sample with the virtual IF stains of the first type using the first trained ML model; and provide the virtually stained image of the target tissue sample with the virtual IF stains of the first type.

One example non-transitory computer-readable medium comprising processor-executable instructions configured to cause one or more processors to receive a slide image of a target tissue sample of a particular tissue type; select a first trained machine learning (ML) model to generate virtual immunofluorescence (IF) stains of a first type for the particular tissue type; generate a virtually stained image of the target tissue sample with the IF stains of the first type using the first trained ML model; and provide the virtually stained image of the target tissue sample with the IF stains of the first type.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated into and constitute a part of this specification, illustrate one or more certain examples and, together with the description of the example, serve to explain the principles and implementations of the certain examples.

FIG. 1 shows an example system for virtual staining of tissue samples using immunofluorescence microscopy and deep learning;

FIGS. 2-6 show comparisons between images for real IF stains and images for virtual IF stains for a breast tissue sample corresponding to five stain types;

FIG. 7 shows an example method for training an ML model for virtual stain generation used in FIG. 1;

FIG. 8 shows an example method for generating a virtually stained image of a tissue sample using a trained ML model for virtual stain generation from FIG. 7; and

FIG. 9 shows an example computing device suitable for use in example systems or methods for generating a virtually stained image of a tissue sample using a trained ML model for virtual stain generation according to this disclosure.

### DETAILED DESCRIPTION

Examples are described herein in the context of virtual IF staining of tissue samples using deep learning. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

The assessment of breast cancer by pathologists requires the visualization of multiple biomarkers via the staining of a tissue sample. The tissue sample is surgically removed via a biopsy or resection, then sectioned onto a slide. Key biomarkers in breast cancer include estrogen receptor (ER), progesterone receptor (PR), human epidermal growth factor receptor 2 (HER2) (e.g., HER2-extra cellular domain (HER2-ECD) or HER2-intracellular domain (HER2-ICD)), and Antigen Kiel 67 (Ki-67). Additionally, nuclear stains (e.g., DAPI or Hoechst) and pan-cytokeratin (PanCK) stains provide information on tissue structure and morphology for the identification of tumor regions. Multiplex immunofluorescence (IF) enables the staining of these biomarkers to be performed simultaneously on a single tissue slide and subsequently visualized together in a single image for assessment by pathologists. However, this process requires the use of chemicals for staining and is destructive to the tissue sample. It is also time consuming and expensive, requiring experienced histotechnicians to prepare the slides and resulting in a turnaround time of about a day before pathologists can assess the tissue. There may also be variability in the stains based on the laboratory, histotechnicians, etc.

Examples of novel imaging and computational approaches are provided to virtually stain unstained tissue to address challenges in conventional histopathology workflows. Virtual staining leverages artificial intelligence to generate synthetic images of tissue slides with predictions of the result of certain staining. Existing virtual immunohistochemical staining does not enable multiple biomarkers to be visualized together in a single image. In contrast, the proposed virtual IF staining can generate IF stains of multiple types from a single slide image. Importantly, the process is non-destructive, with the tissue samples remaining unstained and available for other analyses.

The application of these solutions can be demonstrated in the context of biomarker staining of breast cancer tissue. For examples, a virtual ER stain, together with virtual nuclear and pan-cytokeratin (PanCK) stains, for a breast cancer tissue sample can be generated using a trained ML model. The ML model can be trained based on stain images of the same tissue sections with multiplex IF stains (e.g., Hoechst, PanCK, ER, etc.).

The virtual ER stain (presented with Hoechst and PanCK) can be evaluated using a reader study with board-certified pathologists. All cases can be presented to each pathologist in a randomized order and the pathologists were blinded to the staining modality (real or virtual). In the blinded and randomized reader study, pathologists can assess the slide-level biomarker status. The concordance between the biomarker status on real and virtual ER stains can be evaluated using metrics such as linearly weighted kappa. Linearly weighted kappa values that are above 90% can indicate high concordance. Additionally, computational metrics of total PanCK area and ER-positive nuclei count on real and virtual slides achieved correlation coefficients of 0.91 and 0.92, respectively. These results demonstrate that performance of non-destructive virtual IF staining is equivalent to conventional staining for the assessment of slide-level biomarker status.

These example virtual IF staining techniques described herein are not limited to breast tissues, but applicable to any suitable tissues. Virtual IF staining with deep learning can improve histopathology workflows and provide a new path for downstream analysis with limited biopsy tissue. The virtual IF staining techniques described herein do not require the use of chemicals, thus preserving the tissue for future use. In addition, the virtual staining process is fast, for example, with a turnaround time of less than an hour during the inference phase. Moreover, the virtual staining process generates virtual IF stains, which enables multiple biomarkers to be visualized together in a single image. Virtual staining with deep learning is also deterministic or consistent, that is, the same virtual stains can be produced given the same tissue slide. To sum, the virtual IF staining with deep learning enables efficient use of valuable histological tissue, produces less chemical waste, uses less equipment or reagents, generates virtual IF stains faster with lower cost and less human labor, and provides consistent staining results.

This illustrative example is given to introduce the reader to the general subject matter discussed herein and the disclosure is not limited to this example. The following sections describe various additional non-limiting examples and examples of generating virtual IF stain images from whole slide images using deep learning.

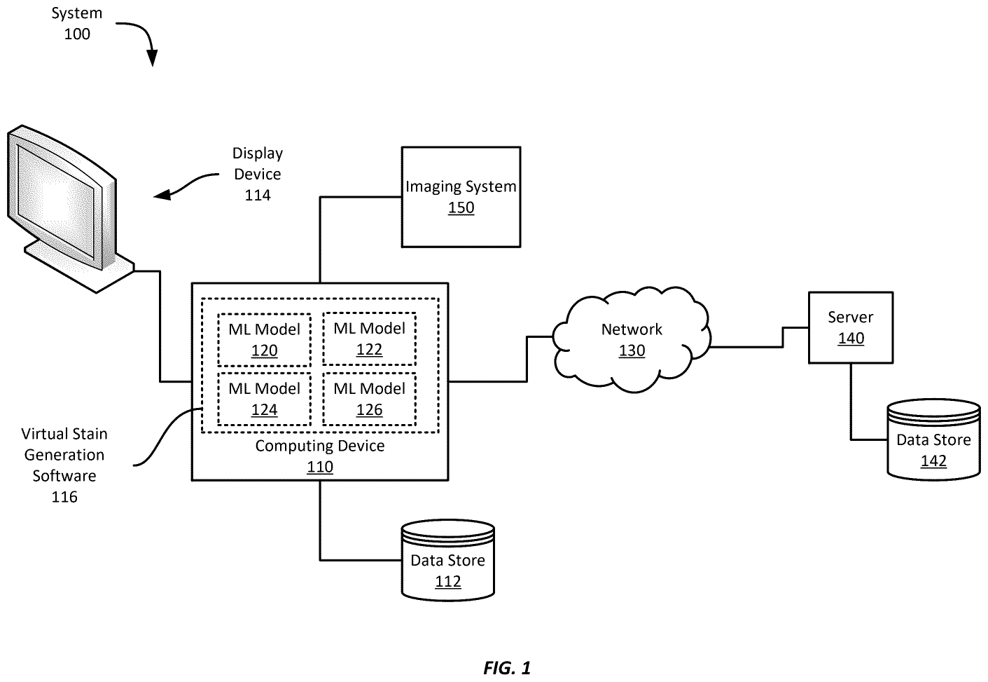

Referring now to FIG. 1, FIG. 1 shows an example system 100 for virtual staining of tissue samples using immunofluorescence microscopy and deep learning. The system 100 includes an imaging system 150 that is connected to a computing device 110. The computing device 110 has virtual stain generation software 116, which includes multiple ML models 120-126 stored in memory for generating virtual IF stains, and is connected to an imaging system 150, a display device 114, a local data store 112, and to a remote server 140 via one or more communication networks 130. The remote server 140 is, in turn, connected to its own data store 142.

The multiple ML models 120-126 in the virtual stain generation software 116 can be trained and provided by the remote server 140. The ML models 120, 122, 124, and 126 are just examples of trained ML models. There can be less than four trained ML models or more than four trained ML models in the virtual stain generation software 116.

The remote server 140 can train an ML model and provide one or more trained ML models for generating virtual IF stains of one or more stain types. In some examples, the remote server 140 accesses one or more sets of stain images of a set of training tissue samples of the same tissue type. The one or more sets of stain images correspond to one or more stain types. In some examples, a training tissue sample is stained with multiplex IF staining. Multiplex IF staining involves applying multiple types of antibodies associated with fluorophores to a training tissue sample. A first set of multiple types of antibodies can bind to different types of proteins (e.g., biomarkers). Another set of antibodies containing different fluorophores (or molecules that can emit a specific color when excited with a laser) can be added to bind with the first set of different types of antibodies. The stained training tissue sample can be excited under a hyperspectral microscope to emit different colors. A spectral unmixing algorithm can be applied to emission spectra of the stained training tissue sample to obtain multiple sets of virtually stained images of corresponding IF stain types. For example, if the tissue samples are from breast tissues, several IF stain types for corresponding biomarker or cell structures, including nuclear stain, PanCK stain, ER stain, HER2_ICD stain, HER2-ECD stain, Ki-67 stain, and PR stain, can be applied to a training tissue sample at the same time, meaning that all stains are present simultaneously in the sample, even if they are not applied simultaneously. Stain images with corresponding stain types can be obtained using a spectral unmixing algorithm to the emission spectra of the stained breast tissue sample. In some examples, stain images of two or more stains can be obtained, which can be used for training ML models. For example, stain images of a biomarker stain (e.g., ER stain, HER_ICD stain, HER2_ECD stain, Ki-67 stain, or PR stain) and stains for morphological features (e.g., nuclear stain or PanCK stain) can be obtained for training ML models for generating virtually stained images of corresponding biomarker stains.

In some examples, the remote server 140 generates and applies a tissue mask to the one or more set of virtually stained images to generate one or more sets of updated virtually stained images. Certain images may include tissue edges showing edge effects, for example tearing, deformation, or damage at the edges, leading to local discrepancies between adjacent sections. Masks can be generated to exclude edges or other portions of virtually stained images from being used in model training. A tissue mask can be generated for the one set of virtually stained images of a training tissue sample with a specific type of virtual stain using a masking model. Masks can be generated at a specific magnification of the one or more sets of virtually stained images.

One or more weighting scheme can be applied in mask generation. For example, a region of interest (ROI)-weighted scheme gives ROIs higher weights in a stain image in generating an ROI-weighted mask. For example, the ROI of a stain image of a breast tissue sample can be determined by the presence of nuclear staining and PanCK staining which highly correlate with tumor regions. For example, an ROI-weighted mask can be generated for stain images with nuclear stain, PanCK stain, ER stain, or HER2_ICD stain. A stain-weighted scheme gives higher stain intensities higher weights in generating a stain-weighted mask. More than one weighting scheme can be used in mask generation. For example, an ROI-weighted and stain-weighted mask can be generated for stain images with Ki-67 stain.

The remote server 140 can generate a multitude of training patches by sampling the one or more sets of updated stain images of corresponding stain types. Patches can be generated from an updated stain image at a 40× magnification. An updated stain image can be sampled or upsampled at random locations based on a sampling probability in corresponding masks to generate image patches. For example, 114 training tissue samples can be stained to obtain five sets of 114 stain images corresponding to five stain types (e.g., PanCK stain, ER stain, HER2_ICD stain, Ki-67 stain). 5,000,000-10,000,000 image patches can be generated from the five sets of 114 stain images corresponding to the five stain types.

The remote server 140 can train an ML model using the multitude of training patch pairs to obtain one or more trained machine learning models for generating virtual stains of one or more IF stain types. The ML model can be a generative adversarial network (GAN)-based ML model. In some examples, the ML model based on a U-Net GAN. An attention gate module can be added to the U-Net GAN to improve segmentation precision and target area distillation. The attention gate module can guide the U-Net model's attention to important regions while suppressing features in unrelated areas of a training image patch.

In some examples, the ML model is a modified version of pix2pix, which is a conditional GAN. The conditional GAN can include a generator based on an attention U-Net architecture and a set of discriminators (e.g., 3) based on a Patch GAN architecture. In some examples, a shift-invariant regression loss is used to minimize the L1 and L2 errors between the real and virtual stains. Conditional and unconditional adversarial losses are used in a minimax game to force the generator to produce realistic images in order to fool the discriminators. A rotational consistency loss is used to make the output rotation invariant and prevent the model from learning any orientation biases. An L2 regularization loss is used to penalize large model weights and reduce overfitting. In some examples, the generator is be trained with a combination of GAN and L1 regularization loss. The set of discriminators can operate at different scales of the image and be trained with least-squares loss. A custom shift variant loss can also be applied. Hyperparameters, such as the bath size, learning rate, learning rate schedules, and loss schedule, can be experimentally determined based on a set of validation data.

In some examples, the model weights are randomly initialized using Glorot uniform initialization and optimized using Adam optimization to minimize the total loss on the training set. All models are trained with a fixed batch size. Learning rate schedules are employed to dynamically change the learning rate over time. Loss schedules are employed to change the relative weights of the shift-invariant regression loss and adversarial loss components over time. During training, the L1 error and Frechet Inception Distance (FID) between the real and virtual stain patches are monitored to ensure model convergence.

In some examples, an ML model is trained with training image patches of multiple types of stains. For example, an ML model for generating virtual IF stains for a cell-state biomarker is trained using image patches with the cell-state biomarker stains and image patches with stains for morphological features. The image patches with stains for morphological features are helpers in training the ML model for generating virtual IF stains for the cell-state biomarker. For example, ER is a biomarker for breast cancer, nuclear and PanCK represent morphological features of breast cancer cells. An ML model can be trained by using image patches with ER stains and the image patches with nuclear stains and PanCK stains to obtain a trained ML model for generating ER stains. Alternatively, training image patches can include more than one stain types, for example one set of training image patches include ER stains, nuclear stains, and PanCK stains. The nuclear stains and PanCK stains are helpers for training the ML model for generating ER stains. Similarly, a trained ML model can be obtained for generating HER2_ICD stain, a trained ML model can be obtained for generating Ki-67 stain. Besides, an ML model can be obtained for generating nuclear stain and PanCK stain. These trained ML models can be provided to a computing device 110 for generating virtual IF stain images.

In another example, the remote server 140 trains an ML model and provide one or more trained ML models for generating virtual IF stains for lung cancer tissue samples. Example key biomarkers of interest for lung cancer include PanCK, cluster of differentiation 3 (CD3), cluster of differentiation 8 (CD8), and programmed cell death ligand 1 (PD-L1). PanCK is expressed in epithelial cells and is useful for the identification of epithelial tumors. CD3 is expressed in T cells, which play an important role in the adaptive immune response. CD8 is predominantly expressed in cytotoxic T cells, but can also be found on natural killer cells and dendritic cells. PD-L1, which may be expressed in both immune cells and tumor cells, suppresses the activity of T cells by binding to the regulatory receptor programmed cell death 1 (PD-1) and contributes to the immune evasion of tumors

In some examples, the remote server 140 trains the ML model to predict pseudo-immunohistochemistry (pIHC) virtual stains and render the corresponding multiplex immunofluorescence (mIF) virtual stains using an inverse pIHC algorithm. Pseudo-IHC (pIHC) refers to immunohistochemistry (IHC)-like images rendered from mIF images using an algorithm based on modeling absorption using the Beer-Lambert law. The algorithm includes two modifications to improve the visual quality of the pIHC images. First, a realistic tissue background was rendered using the unmixed residual autofluorescence signal, which adds tissue morphology details to the image. Second, color offsets were added to match the colors typically observed in real IHC images obtained using brightfield microscopy, such as in regions where no tissue is present. This method results in higher quality virtual stains, compared to training the model to directly predict mIF virtual stains.

While examples are provided for virtual IF straining of breast cancer and lung cancer, the techniques in the present disclosure can also be used to generate virtual IF stains and other types of virtual stains for different cancer types with their corresponding biomarkers.

While the process of training an ML model occurs on the remote server 140, in some examples, a third-party provider (not shown) trains ML models for generating IF stain images. The third-party provider trains ML models for generating different types of virtual IF stains for different tissue types, and provides trained ML models to the remote server 140, which can then provide the trained ML models to the computing device 110.

The imaging system 150 includes a microscope and camera to capture images of pathology samples. Imaging system 150 in this example is a conventional pathology imaging system that can capture digital images of tissue samples, stained or unstained, using broad-spectrum visible light. The imaging system 150 can include (for example) a microscope (e.g., a light microscope) and/or a camera. In some instances, the camera is integrated within the microscope and the microscope can include a stage on which the portion of the sample (e.g., a slice mounted onto a slide) is placed, one or more lenses (e.g., one or more objective lenses and/or an eyepiece lens), one or more focuses, and/or a light source. The camera may be positioned such that a lens of the camera is adjacent to the eyepiece lens. In some instances, a lens of the camera is included within image collection system 104 in lieu of an eyepiece lens of a microscope. The camera can include one or more lenses, one or more focuses, one or more shutters, and/or a light source (e.g., a flash). The digital images from the imaging system 150 can be autofluorescence images. Alternatively, the imaging system 150 can implement other suitable imaging techniques.

The tissue samples can include, but are not limited to, a sample collected via a biopsy (such as a core-needle biopsy), fine needle aspirate, surgical resection, or the like. In one scenario, a tissue sample can be prepared for imaging within the conventional imaging system 150, such as by obtaining one or more thin slices of tissue taken from a patient, and positioning them on corresponding slides, which are then inserted in sequence into the imaging system 150. The imaging system 150 then captures images of unstained samples and provides them to the computing device 110. A set of unstained images may be then generated by the imaging system 160 and each image of the set of images may correspond to different portions of the biological sample.

The computing device 110 receives digital images from the imaging system 150 corresponding to a particular tissue sample and provides them to one of the ML models 120-126 to generate a corresponding virtually stained image of a tissue sample. After receiving the captured unstained image or multiple captured unstained images, the computing device 110 may store the image(s) in the local data store 112. It then executes the virtual stain generation software 116 on an image for a particular biological sample. A set of virtually stained images may then be generated by the virtual stain generation software 116 and each image of the set of virtually stained images may correspond to different biological markers in a particular biological sample on a slide. The virtually stained images can be displayed via a display device 114.

While in this example, the entire process occurs on the local computing device 110 and imaging system 150, such an arrangement is not needed. For example, an example system may omit the imaging system 150. Instead, the computing device 110 could obtain whole slide images from the local data store 112 or from the remote server 140. Alternatively, while virtual stain generation software 116 is executed at the computing device 110, in some examples, the whole slide images may be provided to the remote server 140, which may execute virtual stain generation software 116, including suitable ML models, e.g., ML models 120-126. Thus, the system shown in FIG. 1 may, according to different examples, provide virtually stained images in settings having suitable imaging devices or by receiving images of pathology tissue from a third party for processing, including in a cloud environment provided by a remote server 140.

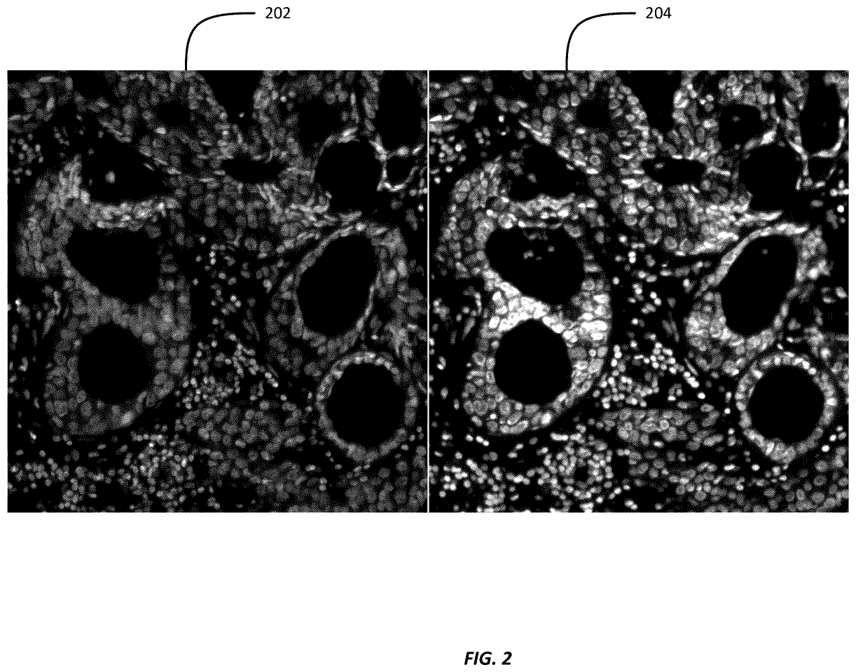

FIGS. 2-6 show comparisons between images for real IF stains and images for virtual IF stains for a breast tissue sample corresponding to five stain types. In an experiment, virtually stained images of five stain types for 32 test slides of breast tissue sample are generated using system 100 in FIG. 1. The five stain types are nuclear stain, panCK stain, ER stain, HER2_ICD stain, Ki-67 stain. Clinicians evaluated the virtually stained images at tissue level and classified the virtually stained images as acceptable, needs improvement, or unacceptable. The criterion for a virtually stained image with virtual nuclear stains as acceptable can be that the virtually stained image identifies 95% of the nuclei correctly. Similarly, the criterion for a virtually stained image with virtual ER stains as acceptable can be that the virtually stained image identifies ER positive correctly within the tissue region. The experiment shows that 100% of the virtual nuclear stain images (e.g., all of the 32 virtual nuclear stain images) are acceptable; 96.9% of the virtual panCK stain images (e.g. 31 of the 32 virtual panCK stain images) are acceptable; 83.9% of the virtual ER stain images (e.g., 27 of the 32 virtual ER stain images) are acceptable; 75% of the virtual HER2_ICD images (e.g., 24 of the 32 virtual HER2_ICD stain images) are acceptable; and 75% of the virtual Ki-67 stain images (e.g., 24 of the 32 virtual Ki-67 stain images) are acceptable. A passing criterion for virtual staining of a stain type can be 75% of the virtually stained images of the stain type for the 32 test slides are acceptable. Thus, virtual staining corresponding to all the five stain types using the system in FIG. 1 pass the evaluation.

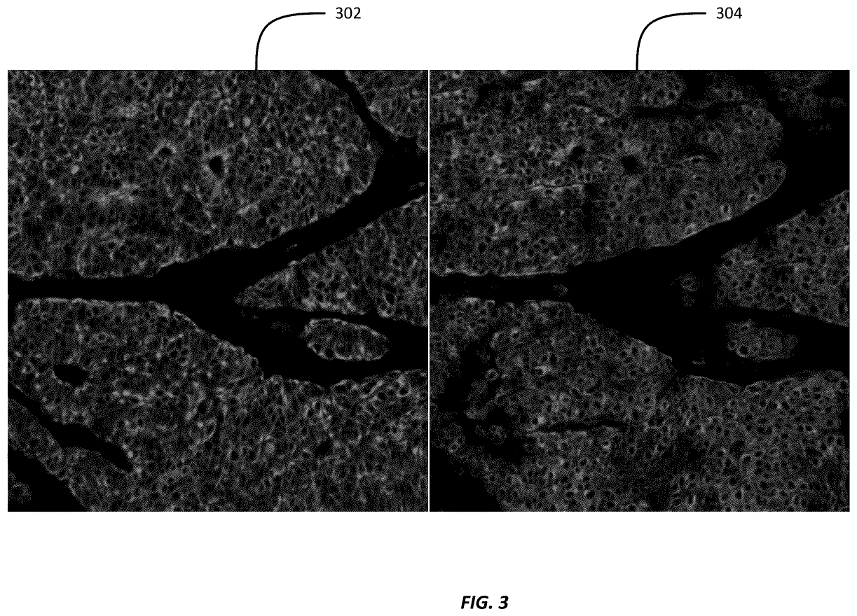

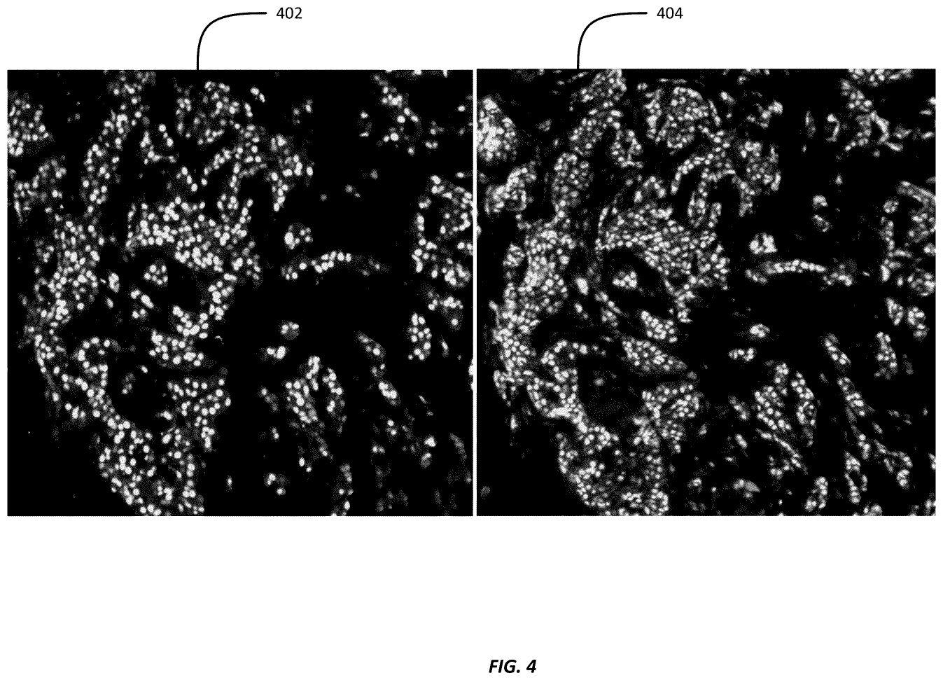

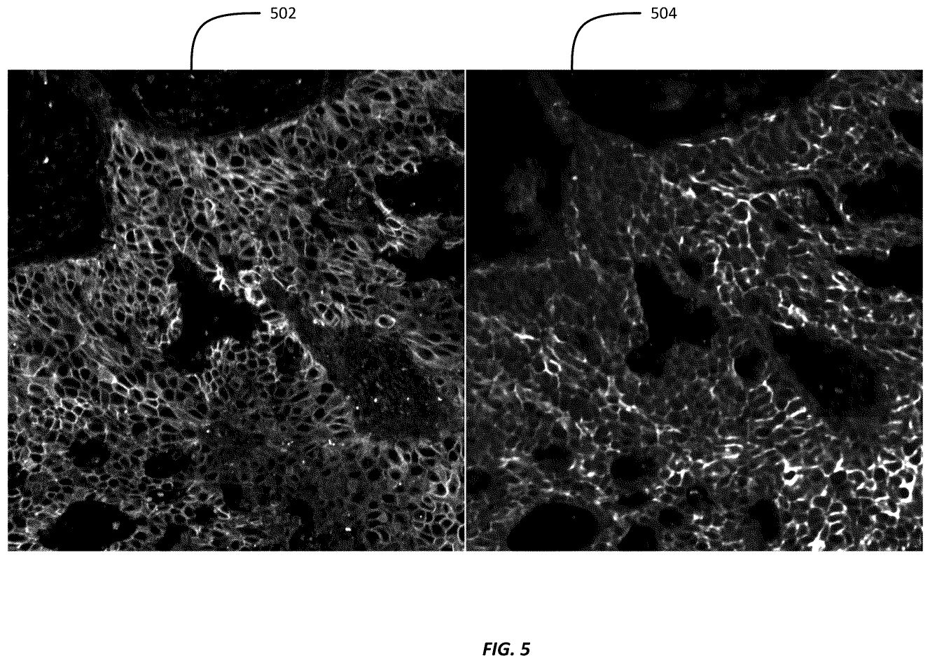

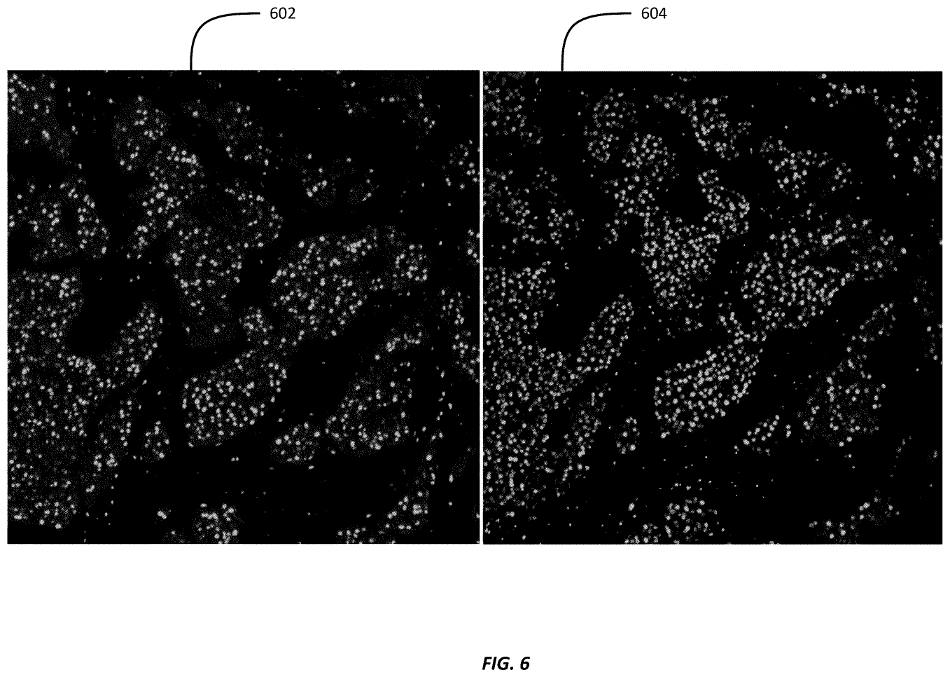

FIG. 2 shows a comparison between image 202 of a real nuclear stain and image 204 of a virtual IF nuclear stain for the breast tissue sample. FIG. 3 shows a comparison between image 302 of a real PanCK stain and image 304 of a virtual IF PanCK stain for the breast tissue sample. FIG. 4 shows a comparison between image 402 of a real ER stain and image 404 of a virtual IF ER stain for the breast tissue sample. FIG. 5 shows a comparison between image 502 of a real HER2-ICD stains and image 504 of a virtual IF HER2-ICD stain for the breast tissue sample. FIG. 6 shows a comparison between image 602 of a real Ki-67 stain and image 604 of a virtual IF Ki-67 stain for the breast tissue sample. It can be shown that the virtual staining performance of the system in FIG. 1 is equivalent to conventional IF staining for the assessment of tissue-level structural features and biomarker status within the cell.

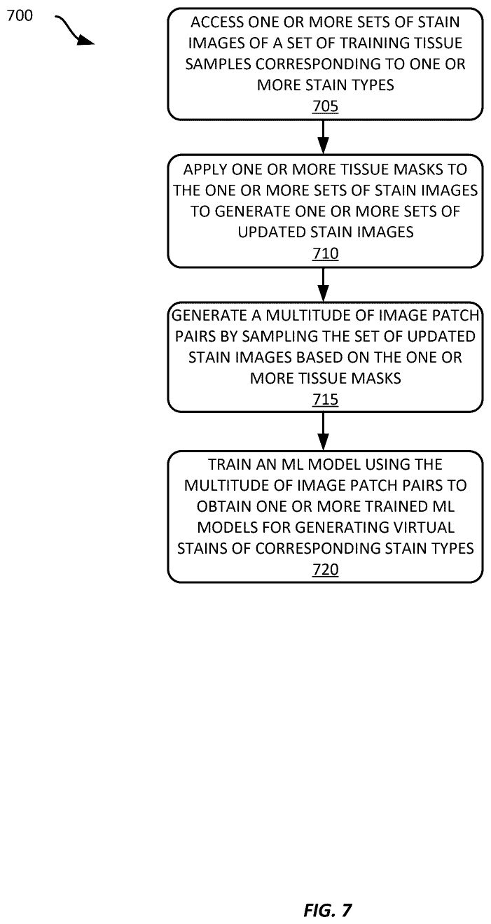

Referring now to FIG. 7, FIG. 7 shows an example method 700 for training an ML model for virtual IF stain generation used in FIG. 1. The method 700 will be described with respect to the example system 100 shown in FIG. 1; however, any suitable system according to this disclosure may be used.

At block 705, a remote server 140 accesses one or more sets of stained images of a set of training tissue samples corresponding to one or more stain types. The set of training tissue samples can be the same tissue type, for example breast tissue. A training sample can be stained with multiplex immunofluorescence staining to generate multiple stain images of different stain types, generally as described in FIG. 1. For example, IF-stained training tissue sample can be excited at multiple excitation-emission wavelengths. A hyperspectral microscope, such as a custom-built hyperspectral programmable array microscope (HPAM), can be used to capture fluorescence images. A spectral unmixing algorithm can be applied to emission spectra of the IF-stained training tissue sample so that one or more stained images of a training sample with corresponding IF stain types can be obtained.

At block 710, the remote server 140 applies one or more tissue masks to the one or more sets of stain images to generate one or more sets of updated stain images. Certain stain images may include tissue edges showing edge effects, for example tearing, deformation, or damage at the edges, leading to local discrepancies between adjacent sections. Masks are generated and applied to exclude edges or other portions of a stain image from model training. One or more weighting scheme can be applied in mask creation. A region of interest (ROI)-weighted scheme gives ROIs higher weights in a training image in generating an ROI-weighted mask. For example, the ROI of a training image can be determined by the presence of nuclear staining and panCK staining which highly correlate with tumor regions. An ROI-weighted mask can be generated for stain images with nuclear stain, panCK stain, ER stain, or HER2_ICD stain. A stain-weighted scheme gives higher stain intensities higher weights in generating a stain-weighted mask. More than one weighting scheme can be applied in mask generation. For example, an ROI-weighted and stain-weighted mask is generated for stain images with Ki-67 stain.

At block 715, the remote server 140 generates a multitude of training image patches by sampling the set of updated stain images based on the one or more tissue masks. Patches can be generated at a 40× magnification of a stain image. An updated stain image can be sampled or upsampled at random locations in corresponding masks based on a sampling probability. In some examples, 10,000-20,000 image patches can be sampled from one stain image.

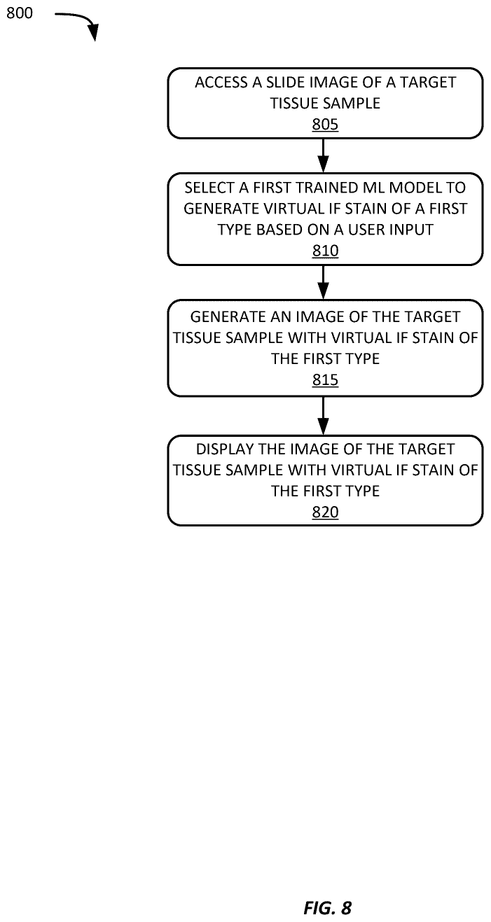

At block 720, the remote server 140 trains an ML model using the multitude of training image patches to obtain one or more trained ML models for generating virtual stains of corresponding IF stain types. The ML model is a modified U-Net GAN with an attention gate module. In some examples, an ML model for generating virtual IF stains for a cell-state biomarker is trained using image patches with the cell-state biomarker stains and image patches stained with morphological features. For example, an ML model for generating virtual ER stain can be trained using both the image patches with ER stains and the image patches with nuclear stains and PanCK stains. The image patches with nuclear stains and PanCK stains are helpers in training the ML model for generating ER stains. One or more trained ML models can be obtained for generating virtually stained images of corresponding stain types. The one or more trained ML models can be provided to a computing device 110 for generating virtually stained images, as will be described in FIG. 8.

FIG. 7 illustrates a method for training an ML model for generating virtually stained images of a corresponding IF stain type. However, not every step in the example method 700 is needed, or some other steps may be added. The example method 700 is performed by a remote server 140. Alternatively, the example method 700 can be performed by the computing device 110.

Referring now to FIG. 8, FIG. 8 shows an example method 800 for generating a virtually stained image of a tissue sample using a trained ML model for virtual stain generation from FIG. 7. The method 800 will be described with respect to the example system 100 shown in FIG. 1; however, any suitable system according to this disclosure may be used.

At block 805, the computing device 110 accesses a slide image of a target tissue sample. In some examples, the target tissue sample is collected from a breast cancer resection. The target tissue sample can be unstained. Alternatively, or additionally, the target tissue sample is stained with PanCK immunofluorescence stains. Alternatively, or additionally, the target sample is stained with nuclear IF stains. The slide image can be obtained via autofluorescence imaging using a microscope.

At block 810, the computing device 110 selects a first trained ML model for generating virtual IF stains of a first type based on a user input. The computing device 110 can select the first trained ML model corresponding to an IF stain type that a user associated with the computing device 110 selects to generate for the target tissue sample. In some examples, the computing device 110 displays a list of different stain types available for a particular sample type in a GUI. The user can navigate to and select different stain types for review. When the user selects a particular stain type by activating a corresponding icon button, the computing device 110 selects the corresponding trained ML model for generating the virtually stained image of the particular stain type. The user can select more than one stain type for review in sequence or at the same time. The computing device 110 then selects corresponding trained ML models for generating virtual stains of corresponding stain types in sequence or at the same time.

At block 815, the computing device 110 generates an image of the target tissue sample with virtual IF stains of the first type using the first trained ML model. The computing device 110 provides the slide image of the target tissue sample received at block 805 as input to the first trained ML model selected at block 810. The first trained ML model can generate an image of the target tissue sample with virtual IF stains of the first type. When two or more IF stain types are selected, corresponding two or more trained ML models can generate corresponding virtually stained images of the target tissue sample.

At block 820, the computing device 110 displays the image of the target tissue sample with virtual IF stains of the first type. The computing device 110 can display the image of the target tissue sample with virtual IF stains of the first type in a GUI via a display device 114. When more than one stain type is selected, virtually stained images of the target tissue sample corresponding to different stain types can be displayed side by side or superimposed on the original image received at block 805.

FIG. 8 illustrates a method for generating virtual IF stain images. However, not every step in the example method 800 is needed, or some other steps may be added. The example method 800 is performed by a computing device 110. Alternatively, the example method 800 can be performed by a remote server 140.

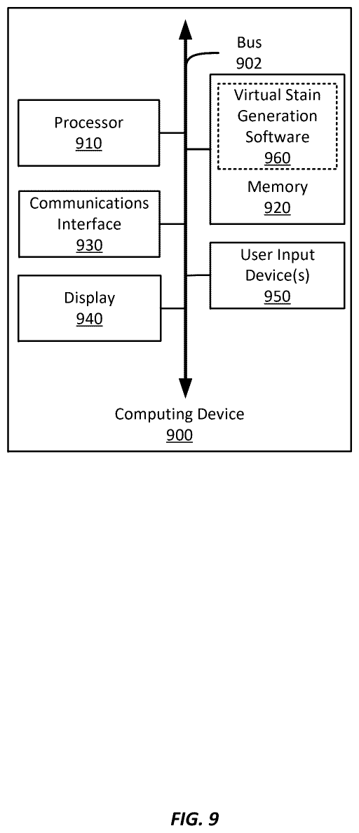

Referring now to FIG. 9, FIG. 9 shows an example computing device 900 suitable for use in example systems or methods for generating a virtually stained image of a tissue sample using a trained ML model for virtual stain generation according to this disclosure. The example computing device 900 includes a processor 910 which is in communication with the memory 920 and other components of the computing device 600 using one or more communications buses 902. The processor 910 is configured to execute processor-executable instructions stored in the memory 920 to perform one or more methods for training ML models or generating virtually stained images according to different examples, such as part or all of the example methods 700 or 800 described above with respect to FIG. 7 or FIG. 8. In this example, the memory 920 includes a virtual stain generation software 960, such as the example system shown in FIG. 1. In addition, the computing device 900 also includes one or more user input devices 950, such as a keyboard, mouse, touchscreen, microphone, etc., to accept user input; however, in some examples, the computing device 900 may lack such user input devices, such as remote servers or cloud servers. The computing device 900 also includes a display 940 to provide visual output to a user.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a slide image of a target tissue sample of a particular tissue type;
selecting a first trained machine learning (ML) model to generate virtual immunofluorescence (IF) stains of a first type for the particular tissue type based on a user input, wherein the first trained ML model is trained at least based on a first set of stain images of a plurality of training tissue samples with stains of the first type;
generating a virtually stained image of the target tissue sample with the virtual IF stains of the first type using the first trained ML model; and
displaying the virtually stained image of the target tissue sample with the virtual IF stains of the first type.

2. The method of claim 1, wherein the slide image of the target tissue sample comprises an autofluorescence image of the target tissue sample in an unstained condition.

3. The method of claim 1, wherein the slide image of the target tissue sample comprises an image of the target tissue sample with PanCK IF stains.

4. The method of claim 1, wherein the slide image of the target tissue sample comprises an image of the target tissue sample stained with nuclear IF stains.

5. The method of claim 1, wherein the first trained ML model comprises a generative adversarial network.

6. The method of claim 1, wherein the first trained ML model comprises a modified U-Net.

7. The method of claim 6, wherein the modified U-Net comprises an attention gate module.

8. The method of claim 1, wherein the first trained ML model is trained based on the first set of stain images of a plurality of training tissue samples with stains of the first type and a second set of stain images of the plurality of training tissue samples with stains of a second type, wherein the stains of the first type are associated with a cell-state biomarker for a type of cancer cells, and wherein the stains of the second type are associated with morphological structures of the type of cancer cells.

9. The method of claim 1, further comprising:
selecting multiple trained ML models to generate virtual IF stains of multiple types for the particular tissue type based on the user input;
generating multiple virtually stained images of the target tissue sample with the virtual IF stains of the multiple types using the multiple trained ML models respectively; and
displaying the multiple virtually stained images of the target tissue sample.

10. A system comprising:
a non-transitory computer-readable medium;
one or more processors in communication with the non-transitory computer-readable medium, the one or more processors configured to execute processor-executable instructions stored in the non-transitory computer-readable medium configured to cause the one or more processors to:
receive a slide image of a target tissue sample of a particular tissue type;
select a first trained machine learning (ML) model to generate virtual immunofluorescence (IF) stains of a first type for the particular tissue type based on a user input, wherein the first trained ML model is trained at least based on a first set of stain images of a plurality of training tissue samples with stains of the first type;
generate a virtually stained image of the target tissue sample with the virtual IF stains of the first type using the first trained ML model; and
cause the virtually stained image of the target tissue sample with the virtual IF stains of the first type to be displayed.

11. The system of claim 10, wherein the slide image of the target tissue sample comprises an autofluorescence image of the target tissue sample in an unstained condition.

12. The system of claim 10, wherein the slide image of the target tissue sample comprises an image of the target tissue sample with PanCK IF stains.

13. The system of claim 10, wherein the slide image of the target tissue sample comprises an image of the target tissue sample stained with nuclear IF stains.

14. The system of claim 10, wherein the first trained ML model comprises a modified U-Net generative adversarial network (GAN), and wherein the modified U-Net GAN comprises an attention gate module.

15. The system of claim 10, wherein the first trained ML model is trained based on the first set of stain images of a plurality of training tissue samples with stains of the first type and a second set of stain images of the plurality of training tissue samples with stains of a second type, wherein the stains of the first type are associated with a cell-state biomarker for a type of cancer cells, and wherein the stains of the second type are associated with morphological structures of the type of cancer cells.

16. The system of claim 10, wherein the one or more processors are configured to execute further processor-executable instructions stored in the non-transitory computer-readable medium to:
select multiple trained ML models to generate virtual IF stains of multiple types for the particular tissue type based on the user input;
generate multiple virtually stained images of the target tissue sample with the virtual IF stains of the multiple types using the multiple trained ML models respectively; and
cause the multiple virtually stained images of the target tissue sample to be displayed.

17. A non-transitory computer-readable medium comprising processor-executable instructions configured to cause one or more processors to:
receive a slide image of a target tissue sample of a particular tissue type;
select a first trained machine learning (ML) model to generate virtual immunofluorescence (IF) stains of a first type for the particular tissue type based on a user input, wherein the first trained ML model is trained at least based on a first set of stain images of a plurality of training tissue samples with stains of the first type;
generate a virtually stained image of the target tissue sample with the virtual IF stains of the first type using the first trained ML model; and
cause the virtually stained image of the target tissue sample with the virtual IF stains of the first type to be displayed.

18. The non-transitory computer-readable medium of claim 17, wherein the first trained ML model comprises a modified U-Net generative adversarial network (GAN), and wherein the modified U-Net GAN comprises an attention gate module.

19. The non-transitory computer-readable medium of claim 17, wherein the first trained ML model is trained based on the first set of stain images of a plurality of training tissue samples with stains of the first type and a second set of stain images of the plurality of training tissue samples with stains of a second type, wherein the stains of the first type are associated with a cell-state biomarker for a type of cancer cells, and wherein the stains of the second type are associated with morphological structures of the type of cancer cells.

20. The non-transitory computer-readable medium of claim 17, further comprising processor-executable instructions configured to cause one or more processors to:
select multiple trained ML models to generate virtual IF stains of multiple types for the particular tissue type based on the user input;
generate multiple virtually stained images of the target tissue sample with IF stains of the multiple types using the multiple trained ML models respectively; and
cause the multiple virtually stained images of the target tissue sample to be displayed.
